(19) United States
(12) Patent Application Publication
(10) Pub. No.: US 2022/0230182 A1
(43) Pub. Date: Jul. 21, 2022

(54) MONITORING APPARATUS, MONITORING SYSTEM, AND MONITORING METHOD

(71) Applicant: TOSHIBA TEC KABUSHIKI KAISHA, Tokyo (JP)

(72) Inventor: Noriyoshi HARA, Mishima Shizuoka (JP)

(73) Assignee: TOSHIBA TEC KABUSHIKI KAISHA, Tokyo (JP)

(21) Appl. No.: 17/524,205

(22) Filed: Nov. 11, 2021

(30) Foreign Application Priority Data
Jan. 19, 2021 (JP) 2021-006278

(51) Int. Cl. G06Q 30/00; G06K 9/00

(52) U.S. Cl. CPC G06Q 30/018; G06K 2009/00738; G06K 9/00711; G06K 9/00335

(57) ABSTRACT

A monitoring apparatus includes a detection unit and a recording unit. The detection unit detects an erroneous behavior of an operator based on video data obtained by photographing a behavior of the operator who operates a settlement terminal. The recording unit records index data that can identify a range of the video data in which the behavior detected by the detection unit is shown.

### CROSS-REFERENCE TO RELATED APPLICATION

This application is based upon and claims the benefit of priority from Japanese Patent Application No. 2021-006278, filed on Jan. 19, 2021, the entire contents of which are incorporated herein by reference.

### FIELD

Embodiments described herein relate generally to a monitoring apparatus, a monitoring system, and a monitoring method.

### BACKGROUND

A self-service POS terminal is a full self-service type settlement terminal in which a customer performs various operations from registration of purchased merchandise to settlement thereof in principle.

Meanwhile, in the self-service POS terminal, an erroneous operation, in which the merchandise added by the customer to a purchased merchandise group is not correctly registered as the purchased merchandise, may be performed.

Therefore, a behavior of the customer is already photographed by a camera and a clerk confirms a photographed image, thereby making it possible to confirm what kind of operation is performed.

However, it may take a long time for the clerk to detect an erroneous behavior of the customer from a video that records the behavior of the customer.

Considering the above-described circumstances, it is desired that a person in charge such as a clerk or the like can promptly confirm the erroneous behavior related to the operation of the self-service POS terminal.

### DESCRIPTION OF THE DRAWINGS

FIG. 1 is a system configuration diagram of a store in which a self-service POS terminal is introduced according to at least one embodiment;

FIG. 2 is a diagram illustrating a location relationship between the self-service POS terminal and a camera;

FIG. 3 is a schematic diagram illustrating an example of a monitoring image displayed on a display of an attendant terminal;

FIG. 4 is a block diagram illustrating a main circuit configuration of a fraudulent behavior recognition apparatus;

FIG. 5 is a schematic diagram illustrating an example of a message table;

FIG. 6 is a schematic diagram illustrating an example of a time series buffer;

FIG. 7 is a flowchart illustrating a function as a behavior recognition unit;

FIG. 8 is a flowchart illustrating a function as an operation recognition unit;

FIG. 9 is a flowchart illustrating a function as a fraud determination unit;

FIG. 10 is a flowchart illustrating the function as the fraud determination unit;

FIG. 11 is a flowchart illustrating the function as the fraud determination unit; and

FIG. 12 is a flowchart illustrating a function as a notification unit and a video reproduction unit.

### DETAILED DESCRIPTION

A problem to be solved by at least one embodiment is to provide a monitoring apparatus, a monitoring system, and a monitoring method capable of allowing a person in charge such as a clerk or the like to promptly confirm an erroneous behavior related to an operation of a self-service type POS terminal.

In general, according to at least one embodiment, a monitoring apparatus includes a detection unit (detector) and a recording unit (recorder. The detection unit detects an erroneous behavior of an operator based on video data obtained by photographing a behavior of the operator who operates a settlement terminal. The recording unit records index data that can identify a range of the video data in which the behavior detected by the detection unit is shown.

Hereinafter, at least one embodiment will be described with reference to the drawings.

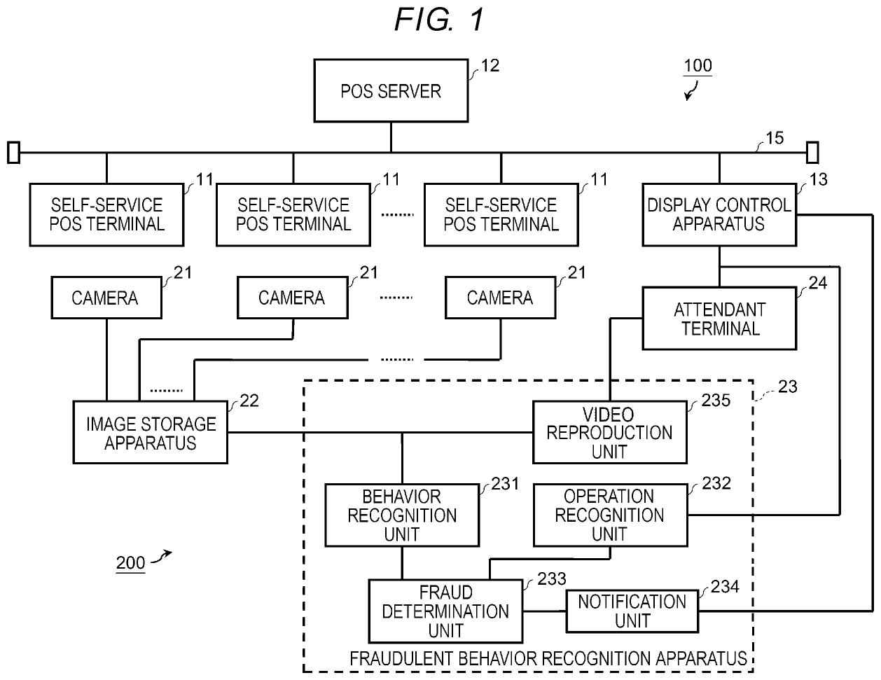

FIG. 1 is a system configuration diagram of a store in which a self-service POS terminal 11 is introduced. The system includes a self-service POS system 100 and a fraudulent behavior recognition system 200. The self-service POS system 100 includes a plurality of self-service POS terminals 11, a POS server 12, a display control apparatus 13, and a communication network 14. The plurality of self-service POS terminals 11, the POS server 12, and the display control apparatus 13 are connected to the communication network 14. The communication network 14 is typically a local area network (LAN). The LAN may be a wired LAN or a wireless LAN.

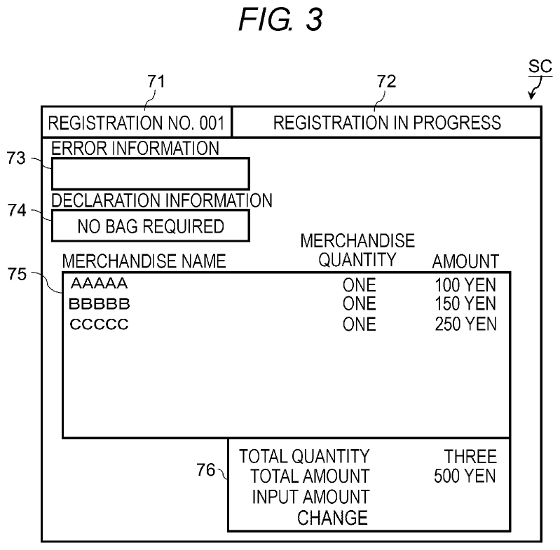

The self-service POS terminal 11 is a full self-service settlement terminal that allows a customer to perform an operation from registration of purchased merchandise to settlement thereof by themselves. The customer may be referred to as a buyer, a consumer, or a client, for example. A clerk may be an operator of the self-service POS terminal 11. However, since the operator of the self-service POS terminal 11 is mainly a customer, the operator will be described below as the customer. The POS server 12 is a server computer for centrally controlling an operation of each self-service POS terminal 11. The display control apparatus 13 is a controller that generates a monitoring image SC (refer to FIG. 3) for each self-service POS terminal 11 based on a data signal output from each self-service POS terminal 11, and displays the generated monitoring image SC on a display device of an attendant terminal 24. Such self-service POS system 100 can be applied as it is from the related arts.

The fraudulent behavior recognition system 200 includes a plurality of cameras 21, an image storage apparatus 22, a fraudulent behavior recognition apparatus 23, and the attendant terminal 24. The plurality of cameras 21 respectively correspond one-to-one to the plurality of self-service POS terminals 11.

The camera 21 is provided for photographing an operator who operates the corresponding self-service POS terminal 11 and outputting imaging data. The imaging data is video data representing the operation of the operator. Therefore, as the camera 21, for example, a video camera having a function of photographing a video is used. The camera 21 is an example of a photographing device.

The image storage apparatus 22 stores the imaging data output from each camera 21 in a built-in storage device in association with a registration number of the self-service POS terminal 11 corresponding to each camera 21. As the image storage apparatus 22, a large-capacity storage apparatus such as a solid state drive (SSD) or a hard disc drive (HDD) can be used alone or in combination.

The fraudulent behavior recognition apparatus 23 has functions as a behavior recognition unit 231, an operation recognition unit 232, a fraud determination unit 233, a notification unit 234, and a video reproduction unit 235. The behavior recognition unit 231 has a function of recognizing a customer's behavior with respect to the self-service POS terminal 11 based on the imaging data stored in the image storage apparatus 22. The operation recognition unit 232 has a function of recognizing a customer's operation with respect to the self-service POS terminal 11 based on data of the monitoring image SC output from the display control apparatus 13 to the attendant terminal 24. The fraud determination unit 233 has a function of determining an erroneous customer behavior (hereinafter referred to as a fraudulent behavior) related to the operation of the self-service POS terminal 11 based on a recognition result by the behavior recognition unit 231 and a recognition result by the operation recognition unit 232.

The notification unit 234 has a function of performing notification if the fraud determination unit 233 determines that the fraudulent behavior is performed. For example, the notification is performed from the attendant terminal 24 to a clerk who is called an attendant and who is a person in charge of monitoring an operation state of each self-service POS terminal 11. The video reproduction unit 235 has a function of causing the attendant terminal 24 to perform video reproduction based on the imaging data stored in the image storage apparatus 22.

The attendant terminal 24 is connected to the display control apparatus 13 and the fraudulent behavior recognition apparatus 23. The attendant terminal 24 is an information terminal apparatus used by the attendant. The attendant terminal 24 includes a display such as a liquid crystal display, an organic EL display, or the like. The attendant terminal 24 divides a screen of the display into a plurality of screen sections, and displays a different monitoring image SC of the attendant terminal 24 for each screen section.

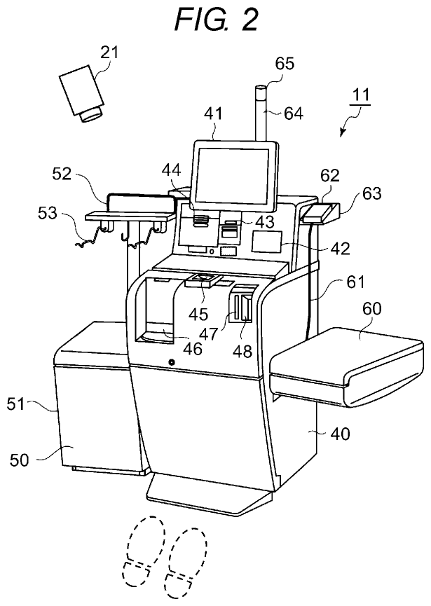

The fraudulent behavior recognition apparatus 23 is an example of a monitoring apparatus. The fraudulent behavior recognition system 200 is an example of a monitoring system. FIG. 2 is a diagram illustrating a location relationship between the self-service POS terminal 11 and the camera 21. First, an appearance configuration of the self-service POS terminal 11 will be described.

The self-service POS terminal 11 includes a main body 40 installed on a floor surface and a bagging stand 50 installed beside the main body 40. The main body 40 includes a touch panel 41 mounted on an upper portion thereof. The touch panel 41 is formed of a display and a touch sensor. The display is a device for displaying various screens to an operator who operates the self-service POS terminal 11. The touch sensor is a device for detecting a touch input to the screen by the operator. In the self-service POS terminal 11, the operator is usually a customer.

The main body 40 includes a basket stand 60 at a center portion of a side surface on a side opposite to a side on which the bagging stand 50 is installed. The basket stand 60 is provided for allowing a customer coming from a sales floor to place a basket or the like including purchased merchandise. The customer stands in a front side of the main body 40 in FIG. 2 to perform their operation so that the screen of the touch panel 41 can be seen. Therefore, when viewed from the customer, the basket stand 60 is provided on a right side of the main body 40, and the bagging stand 50 is provided on a left side thereof in a state where the main body 40 is sandwiched therebetween. In the following description, a side where the customer stands is defined as the front side of the main body 40, and a side where the bagging stand 50 is provided is defined as the left side of the main body 40, and a side where the basket stand 60 is provided is defined as the right side of the main body 40.

The main body 40 forms a scanner reading window 42, a card insertion port 43, a receipt dispensing port 44, a coin input port 45, a coin output port 46, a bill input port 47, and a bill output port 48 in front of the main body 40. A communication cable 61 extends from a right side surface of the main body 40 to the outside, and a reader and writer 62 for an electronic money medium is connected to a tip of the communication cable 61. The reader and writer 62 is disposed on a placement stand 63 provided on an upper right side surface of the main body 40.

The main body 40 includes a display pole 64 mounted on an upper surface thereof. For example, the display pole 64 includes a light emitting unit 65 at a tip portion thereof for selectively emitting blue and red light. The display pole 64 displays a state of the self-service POS terminal 11, such as standby in progress, an operation in progress, calling in progress, an error in progress, or the like, depending on an emission color of the light emitting unit 65.

The bagging stand 50 has a structure in which a bag holder 52 is mounted on an upper portion of a housing 51. The bag holder 52 includes a pair of holding arms 53, and the holding arms 53 hold a plastic shopping bag provided in a store, or a shopping bag brought by a customer, a so-called my bag or the like. Next, the location relationship between the self-service POS terminal 11 and the camera 21 will be described.

As illustrated in FIG. 2, the camera 21 stands in front of the self-service POS terminal 11 and is installed at a location where a customer facing components such as the main body 40, the bagging stand 50, and the basket stand 60 can be photographed from above.

The customer standing in front of the self-service POS terminal 11 first places a basket or the like including the purchased merchandise on the basket stand 60 on the right side, and causes the holding arm 53 on the left side to hold the plastic shopping bag or my bag. Next, the customer operates the touch panel 41 according to guidance displayed on the touch panel 41, and declares start of use of the self-service POS terminal 11. After that, the customer picks up the purchased merchandise one by one from the basket placed on the basket stand 60. If the purchased merchandise is attached with a barcode, the customer registers the merchandise by holding the barcode over the reading window 42 and reading the barcode with a scanner. If the purchased merchandise is not attached with the barcode, the customer registers the merchandise by operating the touch panel 41 and selecting the purchased merchandise from a list of merchandise without the barcode. The customer puts the purchased merchandise of which registration is completed in the plastic shopping bag or my bag.

The customer who registers all the purchased merchandise operates the touch panel 41, and selects a settlement method. For example, if the customer chooses cash settlement, the customer inserts bills into the bill insertion port 47 or coins into the coin insertion port 45, and takes out changes paid out from the bill output port 48 or the coin output port 46. For example, if electronic money settlement is selected, the customer holds an electronic money medium over the reader and writer 62. For example, if credit card settlement is selected, the customer inserts a credit card into the card insertion port 43. If the settlement is completed as such, the customer receives a receipt dispensed from the receipt dispensing port 44 and leaves the store with the plastic shopping bag or my bag removed from the holding arm 53.

The camera 21 is installed in front of the self-service POS terminal 11 at a location where the movement of the customer's hand behaving as described above can be photographed.

FIG. 3 is a schematic diagram illustrating an example of the monitoring image SC displayed on a display of the attendant terminal 24. As described above, the respective monitoring images SC for the plurality of self-service POS terminals 11 are divided and displayed on the display of the attendant terminal 24. FIG. 3 is an example of the monitoring image SC for one of the self-service POS terminals 11. Since a configuration of the monitoring image SC for other self-service POS terminals 11 is also the same, the description thereof will be omitted here.

As illustrated in FIG. 3, the monitoring image SC includes a registration number column 71, a terminal state column 72, an error information column 73, a declaration information column 74, a detail column 75, and a total column 76.

The registration number column 71 is a column for displaying a registration number. The registration number is a series of numbers which are assigned to the respective self-service POS terminal 11 not to overlap each other, and is provided in order to individually identify each self-service POS terminal 11. The registration number is identification information for identifying each self-service POS terminal 11.

The terminal state column 72 is a column for displaying an operation state of the self-service POS terminal 11. In the embodiment, any one of “standby in progress,” “start of use,” “registration in progress,” “settlement start” and “settlement in progress” is displayed in the terminal state column 72 as the operation state.

The “standby in progress” is a state from settlement end of a previous customer to a declaration of the start of use by a next customer. An initial image is displayed on the touch panel of the self-service POS terminal 11 in the state of “standby in progress.” The initial image is, for example, an image including a touch button for allowing the customer to select whether to use the plastic shopping bag provided in the store or to use my Bag.

The “start of use” is a state in which the customer standing in front of the self-service POS terminal 11 declares the start of use for settlement. The customer performs an operation for selecting whether to use the plastic shopping bag or my bag on the initial image. The selection operation becomes the declaration of the start of use. In response to the selection operation, the operation state of the self-service POS terminal 11 becomes the “start of use”.

The “registration in progress” is a state of receiving a registration operation of the purchased merchandise by the customer themselves. If the first purchased merchandise is registered, the operation state of the self-service POS terminal 11 becomes the “registration in progress”. After that, the operation state of the self-service POS terminal 11 is maintained as the “registration in progress” until the customer declares a shift to settlement.

The “settlement start” is a state in which the customer who completes the registration of the purchased merchandise declares the shift to the settlement. A softkey of [payment] is displayed on the touch panel 41 of the self-service POS terminal 11 in the state of “registration in progress.” The customer who completes the registration of purchased merchandise touches the softkey of [payment]. The operation becomes a declaration of the shift to settlement. In response to the operation, the operation state of the self-service POS terminal 11 becomes the “settlement start.”

The “settlement in progress” is a state of performing a settlement process such as cash settlement, electronic money settlement, credit card settlement, or the like. For example, if bills are inserted into the bill insertion port 47 or coins are inserted into the coin insertion port 45, the operation state of the self-service POS terminal 11 becomes the “settlement in progress.” Next, if the settlement process is completed, the operation state of the self-service POS terminal 11 returns to the “standby in progress”.

The error information column 73 is a column for displaying error information generated in the self-service POS terminal 11. The error information includes a communication error, a running-out of receipt error, or the like.

The declaration information column 74 is a column for displaying a declaration operation content of the customer. For example, if the customer selects my bag, “no bag required” indicating that the plastic shopping bag is unnecessary is displayed.

The detail column 75 is a column for displaying detail information of the purchased merchandise registered in the self-service POS terminal 11. The detailed information is, for example, a merchandise name, a quantity, an amount, or the like of the purchased merchandise. The total column 76 is a column for displaying total information of the purchased merchandise registered in the self-service POS terminal 11. The total information includes a total quantity, a total amount, an input amount, a change, or the like.

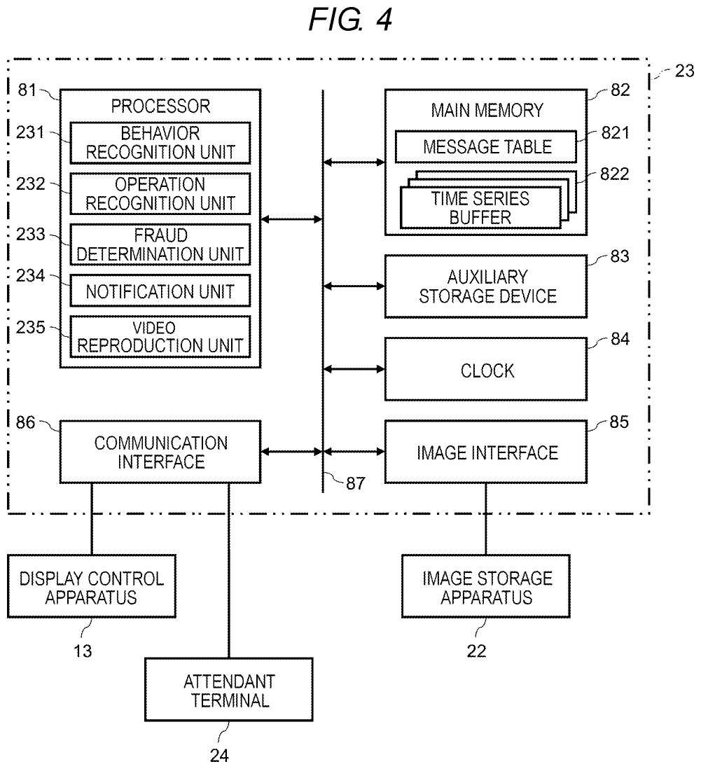

The configuration of the monitoring image SC is not limited thereto. A column in which other items are displayed may be disposed. Items of text data displayed in FIG. 3 are also not limited thereto. Text data of other items may be displayed. FIG. 4 is a block diagram illustrating a main circuit configuration of the fraudulent behavior recognition apparatus 23. The fraudulent behavior recognition apparatus 23 includes a processor 81, a main memory 82, an auxiliary storage device 83, a clock 84, an image interface 85, a communication interface 86, and a system bus 87. The system bus 87 includes an address bus, a data bus, or the like. The fraudulent behavior recognition apparatus 23 forms a computer by connecting the processor 81, the main memory 82, the auxiliary storage device 83, the clock 84, the image interface 85, and the communication interface 86 with the system bus 87. The processor 81 corresponds to a central portion of the computer. The processor 81 controls each unit in order to implement various functions as the fraudulent behavior recognition apparatus 23 according to an operating system or an application program. The processor 81 is, for example, a central processing unit (CPU).

The main memory 82 corresponds to a main memory portion of the computer. The main memory 82 includes a non-volatile memory area and a volatile memory area. The main memory 82 stores the operating system or the application program in the non-volatile memory area. In the volatile memory area, the main memory 82 stores data necessary for the processor 81 to execute a process for controlling each unit. Such type of data may be stored in the non-volatile memory area. The main memory 82 uses the volatile memory area as a work area where data is appropriately rewritten by the processor 81. The non-volatile memory area is, for example, a read only memory (ROM). The volatile memory area is, for example, a random access memory (RAM).

The auxiliary storage device 83 corresponds to an auxiliary storage portion of the computer. As the auxiliary storage device 83, for example, a well-known storage device such as an SSD, an HDD or an electric erasable programmable read-only memory (EEPROM) can be used alone or in combination of a plurality thereof. The auxiliary storage device 83 stores data used by the processor 81 to perform various processes, data generated by the process of the processor 81, or the like. The auxiliary storage device 83 may store the application program.

The application program stored in the main memory 82 or the auxiliary storage device 83 includes a control program which will be described later. A method for installing the control program in the main memory 82 or the auxiliary storage device 83 is not particularly limited. The control program can be recorded on a removable recording medium, or the control program can be distributed by communication via a network, such that the control program can be installed in the main memory 82 or the auxiliary storage device 83. Formation of the recording medium is not limited as long as the recording medium can store a program like a CD-ROM, a memory card, or the like, and can be read by a device.

The clock 84 functions as a time information source of the fraudulent behavior recognition apparatus 23. The processor 81 acquires a current date and time based on information of time tracked by the clock 84.

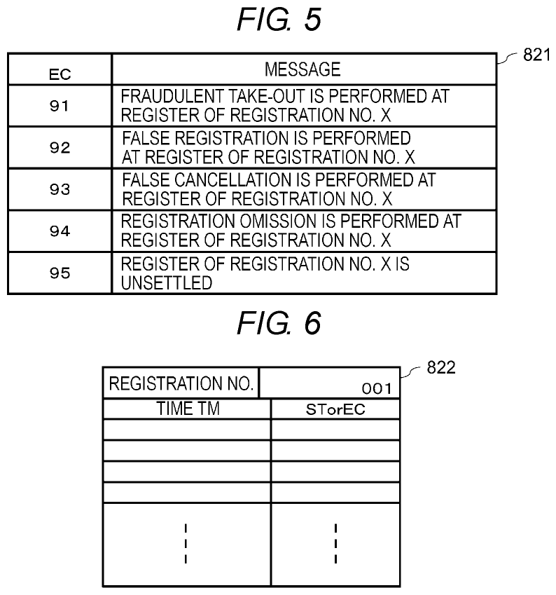

The image interface 85 is an interface for communicating with the image storage apparatus 22. The imaging data stored in the image storage apparatus 22 is taken into the fraudulent behavior recognition apparatus 23 via the image interface 85. The communication interface 86 is an interface for communicating with the display control apparatus 13 and the attendant terminal 24. The imaging data output from the display control apparatus 13 is received into the fraudulent behavior recognition apparatus 23 via the communication interface 86. The imaging data is data of the monitoring image SC generated for each self-service POS terminal 11. Various data output from the attendant terminal 24 are taken into the fraudulent behavior recognition apparatus 23 via the communication interface 86. Various data to be provided to the attendant terminal 24 by the processor 81 are output to the attendant terminal 24 via the communication interface 86. The fraudulent behavior recognition apparatus 23 having such a configuration uses a part of the volatile memory area in the main memory 82 as an area of a message table 821. Next, the fraudulent behavior recognition apparatus 23 forms the message table 821 of a data structure illustrated in FIG. 5 in this area.

FIG. 5 is a schematic diagram illustrating an example of the message table 821. As illustrated in FIG. 5, the message table 821 is a data table in which text data of a message is described in association with an error code EC. The error code EC and the text data of the message associated with the error code EC will be clarified in the following description.

The fraudulent behavior recognition apparatus 23 uses a part of the volatile memory area in the main memory 82 as an area of a time series buffer 822. Next, the fraudulent behavior recognition apparatus 23 forms the time series buffer 822 of a data structure illustrated in FIG. 6 in the area as many as the number of self-service POS terminals 11.

FIG. 6 is a schematic diagram illustrating an example of the time series buffer 822. As illustrated in FIG. 6, the time series buffer 822 includes an area for describing a status ST or the error code EC in the order of earliest time TM according to each registration number that identifies the self-service POS terminal 11. The status ST will also be clarified in the following description.

The fraudulent behavior recognition apparatus 23 implements functions of the behavior recognition unit 231, the operation recognition unit 232, the fraud determination unit 233, and the notification unit 234 described above by the processor 81 and the control program that controls the processor 81, in order to detect a fraudulent behavior of a customer with respect to the self-service POS terminal 11.

The functions as the behavior recognition unit 231, the operation recognition unit 232, the fraud determination unit 233, and the notification unit 234 are functions provided for each self-service POS terminal 11. Therefore, in the following description, the functions of the behavior recognition unit 231, the operation recognition unit 232, the fraud determination unit 233, and the notification unit 234 for one self-service POS terminal 11 will be described in detail. Since the functions as the behavior recognition unit 231, the operation recognition unit 232, the fraud determination unit 233, and the notification unit 234 for other self-service POS terminals 11 are also the same, the description thereof will be omitted here.

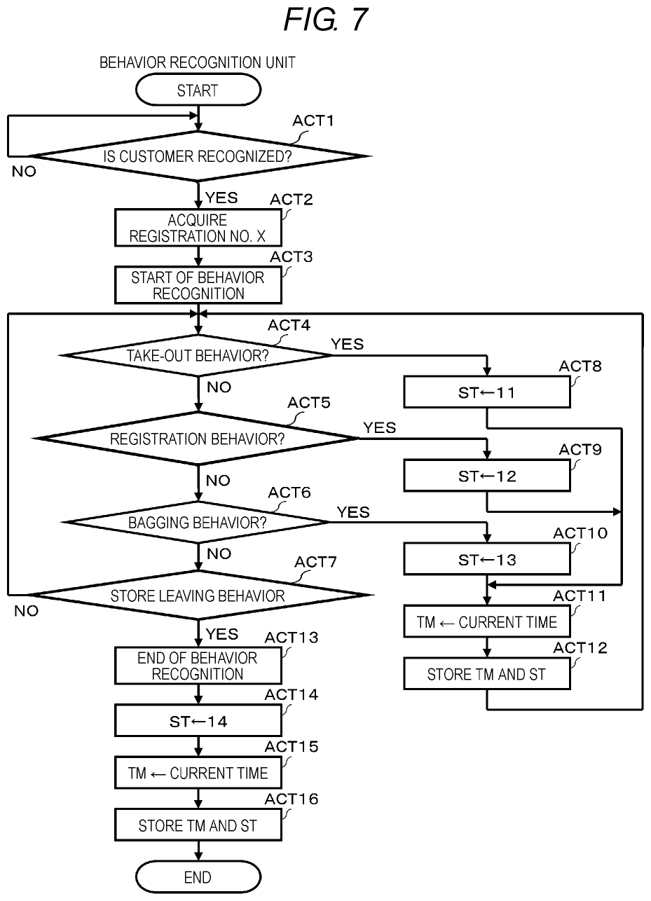

FIG. 7 is a flowchart illustrating the function as the behavior recognition unit 231.

The processor 81 waits for recognizing a customer in ACT 1. The camera 21 is installed at a location where the customer standing in front of the self-service POS terminal 11 can be photographed from above. Therefore, when detecting that a person stands in front of the self-service POS terminal 11 from video data of the camera 21, the processor 81 determines that the customer is recognized.

When recognizing the customer, the processor 81 determines YES in ACT 1 and proceeds to ACT 2. The processor 81 acquires a registration number of the self-service POS terminal 11 in ACT 2. Each camera 21 corresponds one-to-one to each self-service POS terminal 11. Therefore, the processor 81 identifies the self-service POS terminal 11 from identification information of the camera 21 photographing the customer standing in front of the self-service POS terminal 11, and acquires the registration number of the self-service POS terminal 11.

The processor 81 starts to recognize a behavior of the customer in ACT 3. Specifically, the processor 81 estimates a person, that is, a customer's build, from an image photographed by the camera 21. Build estimation can also be implemented with an inexpensive camera 21 by using AI technology such as deep learning or the like. The processor 81 recognizes a take-out behavior, a registration behavior, a bagging behavior, or a store leaving behavior of the customer from hand movement obtained by the build estimation.

The take-out behavior is a behavior of taking out purchased merchandise from a basket placed on the basket stand 60. For example, when detecting movement that the build of one hand or both hands moves to the right side of the main body 40 and lifts the purchased merchandise, the processor 81 recognizes that the take-out behavior is performed.

The registration behavior is a behavior of registering data of the purchased merchandise taken out from the basket in the self-service POS terminal 11. For example, when detecting movement that the build of the hand performing the take-out behavior holds the purchased merchandise over the reading window 42 at the center of the main body 40, the processor 81 recognizes that the registration behavior is performed. Alternatively, when detecting movement that the build of one hand operates the touch panel 41 of the main body 40, the processor 81 recognizes that the registration behavior is performed.

The bagging behavior is a behavior of putting the purchased merchandise of which registration is completed into a plastic shopping bag or my bag of the bagging stand 50. For example, when detecting movement that the build of the hand performing the registration behavior moves to the left side of the main body and then the purchased merchandise is put in the plastic shopping bag or my bag, the processor 81 recognizes that the bagging behavior is performed.

The store leaving behavior is a behavior in which a customer who completes settlement leaves the self-service POS terminal 11. For example, if the build of the hand of the customer who completes the settlement moves to remove the plastic shopping bag or my bag from the holding arm 53, and then the customer cannot be detected from the video data of the camera 21, the processor 81 recognizes that the store leaving behavior is performed.

The processor 81, in ACT 4 to ACT 7, waits for recognizing the take-out behavior, the registration behavior, the bagging behavior, or the store leaving behavior. When recognizing the take-out behavior in this standby state, the processor 81 determines YES in ACT 4 and proceeds to ACT 8. The processor 81 sets the status ST to “11” in ACT 8. When recognizing the registration behavior, the processor 81 determines YES in ACT 5 and proceeds to ACT 9. The processor 81 sets the status ST to “12” in ACT 9. When recognizing the bagging behavior, the processor 81 determines YES in ACT 6 and proceeds to ACT 10. The processor 81 sets the status ST to “13” in ACT 10.

When completing the processes of ACT 8, ACT 9, or ACT 10, the processor 81 proceeds to ACT 11. The processor 81 acquires a current time TM tracked by the clock 84 in ACT 11. Next, the processor 81 describes, in ACT 12, the time TM and the status ST in association with each other in the time series buffer 822 in which the registration number acquired by the process of ACT 2 is set. After that, the processor 81 returns to the standby state of ACT 4 to ACT 7.

As such, if the take-out behavior with respect to the self-service POS terminal 11 is recognized by the function of the behavior recognition unit 231, in the time series buffer 822 in which the registration number of the self-service POS terminal 11 is set, “11” is described as the status ST together with the time TM. In the same manner, if the registration behavior is recognized, “12” is described as the status ST together with the time TM in the time series buffer 822. If the bagging behavior is recognized, “13” is described as the status ST together with the time TM in the time series buffer 822.

Typically, the customer registers the data of the purchased merchandise in the self-service POS terminal 11 by repeating the taking-out behavior, the registration behavior, and the bagging behavior in order with respect to the self-service POS terminal 11. Therefore, the status ST is stored in the time series in the order of “11”, “12”, and “13” in the time series buffer 822.

When recognizing the store leaving behavior in the standby state of ACT 4 to ACT 7, the processor 81 determines YES in ACT 7 and proceeds to ACT 13. The processor 81 ends the behavior recognition of the customer in ACT 13.

The processor 81 that completes the behavior recognition sets the status ST to “14” in ACT 14. The processor 81 acquires the current time TM tracked by the clock 84 in ACT 15. Next, the processor 81 describes, in ACT 16, the time TM and the status ST in association with each other in the time series buffer 822 in which the registration number acquired in the process of ACT 2 is set. Therefore, in the time series buffer 822 corresponding to the self-service POS terminal 11 from which the customer leaves the store, “14” is stored as the status ST together with the time TM.

As described above, the processor 81 ends the function as the behavior recognition unit 231. After that, when detecting again from the video data of the camera 21 that a person stands in front of the self-service POS terminal 11, the processor 81 executes the processes of ACT 2 to ACT 16 in the same manner as described above.

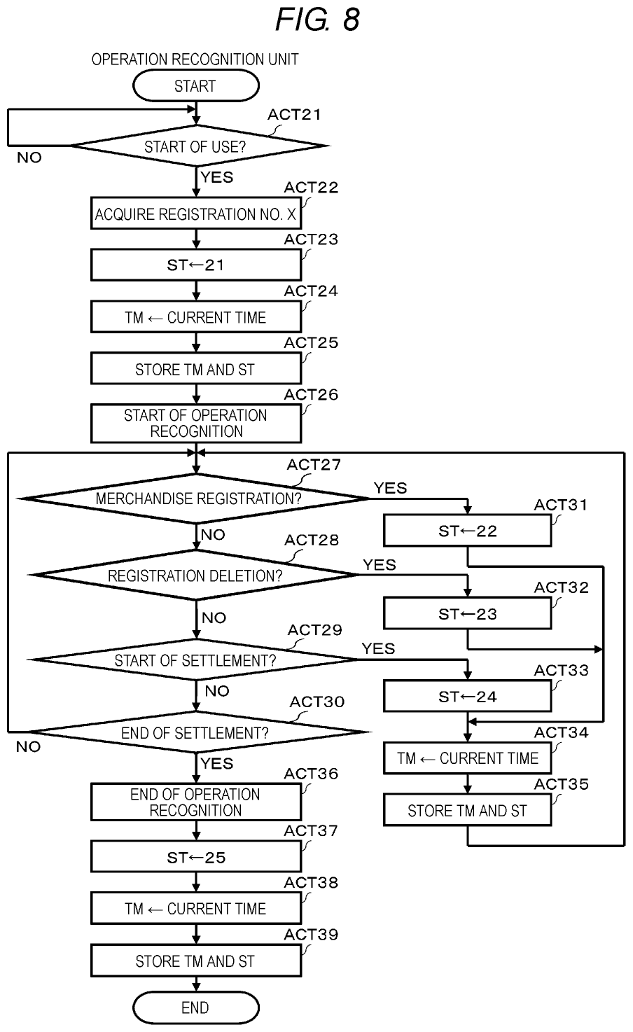

FIG. 8 is a flowchart illustrating a function as the operation recognition unit 232.

The processor 81 waits for a customer to declare start of use with respect to the self-service POS terminal 11 in ACT 21. If the start of use is declared, the “start of use” is displayed in the terminal state column 72 of the monitoring image SC corresponding to the self-service POS terminal 11. The processor 81 confirms whether a character of the “start of use” can be recognized from the terminal state column 72 of the monitoring image SC acquired via the display control apparatus 13. If the character of the “start of use” can be recognized, the processor 81 recognizes that the start of use is declared. When recognizing that the start of use is declared, the processor 81 determines YES in ACT 1 and proceeds to ACT 2. The processor 81 acquires a registration number of the self-service POS terminal 11 in ACT 2. The registration number thereof is displayed in the registration number column 71 of the monitoring image SC. The processor 81 recognizes a character of the registration number from the registration number column 71 of the monitoring image SC acquired via the display control apparatus 13, and acquires the character as the registration number.

The processor 81 sets the status ST to “21” in ACT 23. The processor 81 acquires the current time TM tracked by the clock 84 in ACT 24. Next, the processor 81 describes, in ACT 25, the time TM and the status ST in association with each other in the time series buffer 822 in which the registration number acquired in the process of ACT 22 is set.

Therefore, if the customer standing in front of the self-service POS terminal 11 performs a declaration operation for declaring the start of use, first, “21” is stored as the status ST together with the time TM in the time series buffer 822 corresponding to the self-service POS terminal 11.

The processor 81 starts operation recognition with respect to the self-service POS terminal 11 in ACT 26. Specifically, the processor 81 recognizes a merchandise registration operation, a registration deletion operation, a settlement start operation, or a settlement end operation from the transition of information obtained by character recognition of the monitoring image SC acquired via the display control apparatus 13.

For example, the processor 81 recognizes that the merchandise registration operation is performed when detailed information such as a merchandise name, a quantity, an amount, or the like of the purchased merchandise is added to the detail column 75. For example, the processor 81 recognizes that the registration deletion operation is performed if a total quantity or a total amount displayed in the total column 76 decreases. For example, if the display of the terminal state column 72 is switched to the “settlement start”, the processor 81 recognizes that the settlement start operation is performed. For example, if the display of the terminal state column 72 is switched to the “standby in progress”, the processor 81 recognizes that the settlement end operation is performed.

In ACT 27 to ACT 30, the processor 81 waits for the merchandise registration operation, the registration deletion operation, the settlement start operation, or the settlement end operation to be recognized. When recognizing the merchandise registration operation, the processor 81 determines YES in ACT 27 and proceeds to ACT 31. The processor 81 sets the status ST to “22” in ACT 31. When recognizing the registration deletion operation, the processor 81 determines YES in ACT 28 and proceeds to ACT 32. The processor 81 sets the status ST to “23” in ACT 32. When recognizing the settlement start operation, the processor 81 determines YES in ACT 29 and proceeds to ACT 33. The processor 81 sets the status ST to “24” in ACT 33.

When completing the processes of ACT 31, ACT 32, or ACT 33, the processor 81 proceeds to ACT 34. The processor 81 acquires the current time TM tracked by the clock 84 in ACT 34. Next, the processor 81 describes, in ACT 35, the time TM and the status ST in association with each other in the time series buffer 822 in which the registration number acquired in the process of ACT 22 is set. After that, the processor 81 returns to the standby state of ACT 27 to ACT 30.

As such, if the merchandise registration operation with respect to the self-service POS terminal 11 is recognized by the function of the operation recognition unit 232, “22” is described as the status ST together with the time TM in the time series buffer 822 in which the registration number of the self-service POS terminal 11 is set. In the same manner, if the registration deletion operation is recognized, “23” is described as the status ST together with the time TM in the time series buffer 822. If the settlement start operation is recognized, “24” is described as the status ST together with the time TM in the time series buffer 822.

Typically, the merchandise registration operation or the registration deletion operation is performed on the self-service POS terminal 11 by the registration behavior of the customer. Therefore, the status ST indicating the registration behavior, that is, after “12”, the status indicating the merchandise registration operation or the registration deletion operation, that is, “22” or “23” is stored in the time series buffer 822.

The customer who completes the bagging behavior of all the purchased merchandise declares the settlement start. Therefore, the status ST indicating the bagging behavior, that is, after “13”, the status indicating the settlement start operation, that is, “24” is stored in the time series buffer 822.

When recognizing the settlement end operation in the standby state of ACT 27 to ACT 30, the processor 81 determines YES in ACT 30 and proceeds to ACT 36. The processor 81 ends the operation recognition with respect to the self-service POS terminal 11 in ACT 36.

The processor 81 that ends the operation recognition sets the status ST to “25” in ACT 37. The processor 81 acquires the current time TM tracked by the clock 84 in ACT 38. Next, the processor 81 describes, in ACT 39, the time TM and the status ST=25 in association with each other in the time series buffer 822 in which the registration number acquired in the process of ACT 22 is set. Therefore, “25” is stored as the status ST together with the time TM in the time series buffer 822 corresponding to the self-service POS terminal 11 of which settlement is completed.

As described above, the processor 81 ends the function as the operation recognition unit 232. After that, when detecting an operation of the start of use of the self-service POS terminal 11 again from the data of the monitoring image SC, the processor 81 executes the processes of ACT 22 to ACT 29 in the same manner as described above.

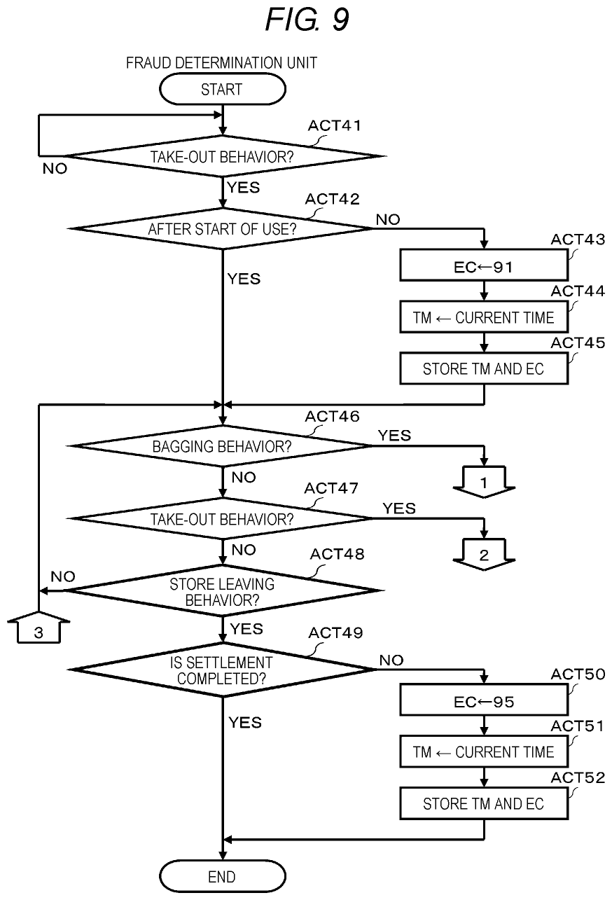

FIGS. 9 to 11 are flowcharts illustrating a function as the fraud determination unit 233.

The processor 81 waits for the behavior recognition unit 231 to recognize the take-out behavior in ACT 41. As described above, “11” is described as the status ST in the time series buffer 822 in which the registration number of the self-service POS terminal 11 in which the take-out behavior is recognized is set. When detecting that “11” is described as the status ST in the time series buffer 822, the processor 81 determines YES in ACT 41 and proceeds to ACT 42.

The processor 81 confirms whether the take-out behavior is performed after the operation of the start of use in ACT 42. If the operation of the start of use is performed on the self-service POS terminal 11, “21” is described as the status ST in the time series buffer 822. Therefore, the processor 81 searches the time series buffer 822 in a direction of going back to that time from the time TM in which “11” is described as the status ST. Next, when detecting that “21” is described as the status, the processor 81 determines that the take-out behavior is performed after the operation of the start of use. On the other hand, if “14” or “25” is detected as the status or the search of the time series buffer 822 is completed, the processor 81 determines that the take-out behavior is not performed after the operation of the start of use.

If the take-out behavior is not performed after the start of use, the processor 81 determines NO in ACT 42 and proceeds to ACT 43. The processor 81 sets the error code EC to “91” in ACT 43. The processor 81 acquires the current time TM tracked by the clock 84 in ACT 44. Next, the processor 81 describes, in ACT 45, the time TM and the error code EC in association with each other in the time series buffer 822. After that, the processor 81 proceeds to ACT 46.

On the other hand, if the take-out behavior is performed after the start of use, the processor 81 determines YES in ACT 42. The processor 81 skips the processes of ACT 43 to ACT 45 and proceeds to ACT 46.

Therefore, if the take-out behavior of the merchandise is recognized in the self-service POS terminal 11 where the declaration operation for the start of use is not performed, “91” is stored as the error code EC in the time series buffer 822 in which the registration number of the self-service POS terminal 11 is set.

As such, if the take-out behavior is recognized even though the operation of the start of use is not recognized, “91” is stored as the error code EC in the time series buffer 822. That is, the error code EC “91” is a code that identifies a behavior of a customer who performs the take-out behavior without performing the declaration operation for the start of use as a fraudulent behavior “fraudulent take-out”.

The processor 81 confirms whether the bagging behavior is recognized by the behavior recognition unit 231 in ACT 46. As described above, if the bagging behavior is recognized, “12” is described as the status ST in the time series buffer 822. If “12” is not described as the status ST in the time series buffer 822, the processor 81 determines NO in ACT 46 and proceeds to ACT 47.

The processor 81 confirms whether the take-out behavior is recognized by the behavior recognition unit 231 in ACT 47. As described above, if the take-out behavior is recognized, “11” is described as the status ST in the time series buffer 822. If “11” is not described as the status ST in the time series buffer 822, the processor 81 determines NO in ACT 47 and proceeds to ACT 48.

The processor 81 confirms whether the store leaving behavior is recognized by the behavior recognition unit 231 in ACT 48. As described above, if the store leaving behavior is recognized, “14” is described as the status ST in the time series buffer 822. If “14” is not described as the status ST in the time series buffer 822, the processor 81 determines NO in ACT 48 and returns to ACT 46.

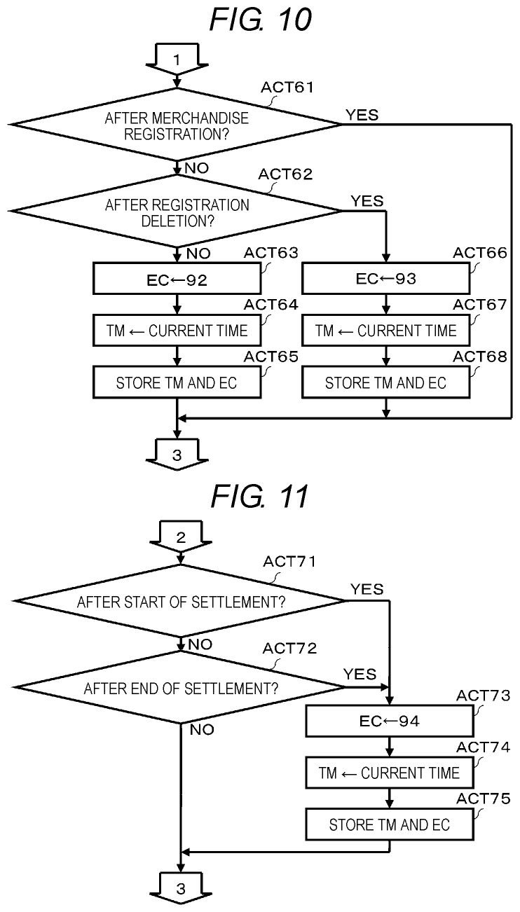

In ACT 46 to ACT 48, here, the processor 81 waits for the customer who performs a behavior of taking out a first merchandise to perform the bagging behavior, perform the take-out behavior of another merchandise, or perform the store leaving behavior. In the standby state, if “13” is described as the status ST in the time series buffer 822, the processor 81 determines YES in ACT 46 and proceeds to ACT 61 of FIG. 10.

The processor 81 confirms whether the bagging behavior is performed after the merchandise registration operation in ACT 61. As described above, if the merchandise registration operation is recognized by the operation recognition unit 232, “22” is described as the status ST in the time series buffer 822. Therefore, if “22” is described as the status ST in association with the time TM which is immediately before the time TM in which “13” is described as the status ST, the processor 81 recognizes that the bagging behavior is performed after the merchandise registration operation. The processor 81 determines NO in ACT 61, and returns to ACT 46 of FIG. 9. That is, the processor 81 returns to the standby state of ACT 46 to ACT 48.

On the other hand, if “22” is not described as the status ST in association with the time TM which is immediately before the time TM in which “13” is described as the status ST, the processor 81 recognizes that the bagging behavior is not performed after the merchandise registration operation. The processor 81 determines YES in ACT 61, and proceeds to ACT 62. The processor 81 confirms whether the bagging behavior is performed after the registration deletion operation in ACT 62. As described above, if the registration deletion operation is recognized by the operation recognition unit 232, “23” is described as the status ST in the time series buffer 822. Therefore, if “23” is described as the status ST in association with the time TM which is immediately before the time TM in which “13” is described as the status ST, the processor 81 recognizes that the bagging behavior is performed after the registration deletion operation. In other words, if “23” is not described as the status ST in association with the time TM which is immediately before the time TM in which “13” is described as the status ST, the processor 81 recognizes that the bagging behavior is not performed after the registration deletion operation.

If the bagging behavior is not performed after the registration deletion operation, the processor 81 determines NO in ACT 62 and proceeds to ACT 63. The processor 81 sets the error code EC to “92” in ACT 63. The processor 81 acquires the current time TM tracked by the clock 84 in ACT 64. Next, the processor 81 describes, in ACT 65, the time TM and the error code EC in association with each other in the time series buffer 822 in which “13” is described as the status ST. After that, the processor 81 returns to ACT 46 of FIG. 9. That is, the processor 81 returns to the standby state of ACT 46 to ACT 48.

As such, if the bagging behavior is recognized even though the merchandise registration operation or the registration deletion operation is not recognized, “92” is stored as the error code EC in the time series buffer 822. That is, “92” of the error code EC is a code that identifies a behavior of a customer who performs the bagging behavior of the merchandise of which merchandise registration operation is not performed as a fraudulent behavior “false registration”.

On the other hand, if the bagging behavior is performed after the registration deletion operation, the processor 81 determines YES in ACT 62 and proceeds to ACT 66. The processor 81 sets the error code EC to “93” in ACT 66. The processor 81 acquires the current time TM tracked by the clock 84 in ACT 67. Next, the processor 81 describes, in ACT 68, the time TM and the error code EC in association with each other in the time series buffer 822 in which “13” is described as the status ST. After that, the processor 81 returns to ACT 46 of FIG. 9. That is, the processor 81 returns to the standby state of ACT 46 to ACT 48.

As such, if the bagging behavior is recognized after recognizing the registration deletion operation, “93” is stored as the error code EC in the time series buffer 822. That is, “93” of the error code EC is a code that identifies a behavior of a customer who performs the bagging behavior of the merchandise of which registration deletion operation is performed as a fraudulent behavior “false cancellation”.

Referring back to the description of FIG. 9, in the standby state of ACT 46 to ACT 48, if “11” is described as the status ST in the time series buffer 822 and the take-out behavior is recognized, the processor 81 proceeds to ACT 71 of FIG. 11. The processor 81 confirms whether the take-out behavior is performed after the settlement start operation in ACT 71. As described above, if the settlement start operation is recognized by the operation recognition unit 232, “24” is described as the status ST in the time series buffer 822. Therefore, if “24” is described as the status ST in association with the time TM which is immediately before the time TM in which “11” is described as the status ST, the processor 81 recognizes that the take-out behavior is performed after the settlement start operation. In other words, if “24” is not described as the status ST in association with the time TM which is immediately before the time TM in which “11” is described as the status ST, the processor 81 recognizes that the take-out behavior is not performed after the settlement start operation. If the take-out behavior is not performed after the settlement start operation, the processor 81 determines NO in ACT 71 and proceeds to ACT 72. The processor 81 confirms whether the take-out behavior is performed after the settlement end operation in ACT 72. As described above, if the settlement end operation is recognized by the operation recognition unit 232, “25” is described as the status ST in the time series buffer 822. Therefore, if “25” is described as the status ST in association with the time TM which is immediately before the time TM in which “11” is described as the status ST, the processor 81 recognizes that the take-out behavior is performed after the settlement end operation. In other words, if “25” is not described as the status ST in association with the time TM which is immediately before the time TM in which “11” is described as the status ST, the processor 81 recognizes that the take-out behavior is not performed after the settlement end operation.

If the take-out behavior is not performed after the settlement end operation, the processor 81 determines NO in ACT 72 and returns to ACT 46 of FIG. 9. That is, the processor 81 returns to the standby state of ACT 46 to ACT 48.

On the other hand, if the take-out behavior is performed after the settlement start operation or after the settlement end operation, the processor 81 determines YES in ACT 71 or ACT 72, and proceeds to ACT 73. The processor 81 sets the error code EC to “94” in ACT 73. The processor 81 acquires the current time TM tracked by the clock 84 in ACT 74. Next, the processor 81 describes, in ACT 75, the time TM and the error code EC in association with each other in the time series buffer 822 in which “11” is described as the status ST. After that, the processor 81 returns to ACT 46 of FIG. 9. That is, the processor 81 returns to the standby state of ACT 46 to ACT 48.

As such, if the merchandise take-out behavior is recognized even though the settlement start operation or the settlement end operation is recognized, “94” is stored as the error code EC in the time series buffer 822. That is, “94” of the error code EC is a code that identifies a behavior of a customer who takes out unregistered merchandise from a basket after the settlement start operation or the settlement end operation as a fraudulent behavior “registration omission”.

Referring back to the description of FIG. 9, in the standby state of ACT 46 to ACT 48, if “14” is described as the status ST in the time series buffer 822 and the store leaving behavior is recognized, the processor 81 determines YES in ACT 48, and proceeds to ACT 49. The processor 81 confirms whether the store leaving behavior is performed after the settlement end operation in ACT 49. As described above, if the settlement end operation is recognized by the operation recognition unit 232, “25” is described as the status ST in the time series buffer 822. Therefore, if “25” is described as the status ST in association with the time TM which is immediately before the time TM in which “14” is described as the status ST, the processor 81 recognizes that the store leaving behavior is performed after the settlement end operation. In other words, if “25” is not described as the status ST in association with the time TM which is immediately before the time TM in which “14” is described as the status ST, the processor 81 recognizes that the store leaving behavior is not performed after the settlement end operation.

If the store leaving behavior is performed after the settlement end operation, the processor 81 determines YES in ACT 49. The processor 81 ends the function as the fraud determination unit 233.

On the other hand, if the store leaving behavior is not performed after the settlement end operation, the processor 81 determines NO in ACT 49 and proceeds to ACT 50. The processor 81 sets the error code EC to “95” in ACT 50. The processor 81 acquires the current time TM tracked by the clock 84 in ACT 51. Next, the processor 81 describes, in ACT 52, the time TM and the error code EC in association with each other in the time series buffer 822 in which “14” is described as the status ST.

As such, if the store leaving behavior is recognized even though the settlement end operation is not recognized, “95” is stored as the error code EC in the time series buffer 822. That is, the error code EC “95” is a code that identifies a behavior of a customer who performs the store leaving behavior before the settlement end operation as a fraudulent behavior “unsettled”.

As described above, the processor 81 ends the function as the fraud determination unit 233. After that, if the take-out behavior is recognized again, the processor 81 executes the processes of ACT 42 to ACT 52, ACT 61 to ACT 68, and ACT 71 to ACT 75 in the same manner as described above.

As such, the processor 81 detects the fraudulent behavior as the erroneous behavior of the customer who is the operator by the behavior recognition unit 231 and the fraud determination unit 233 implemented by executing an information process, based on the imaging data which is the video data. That is, if the processor 81 executes the information process, the computer including the processor 81 as a central portion functions as a detection unit.

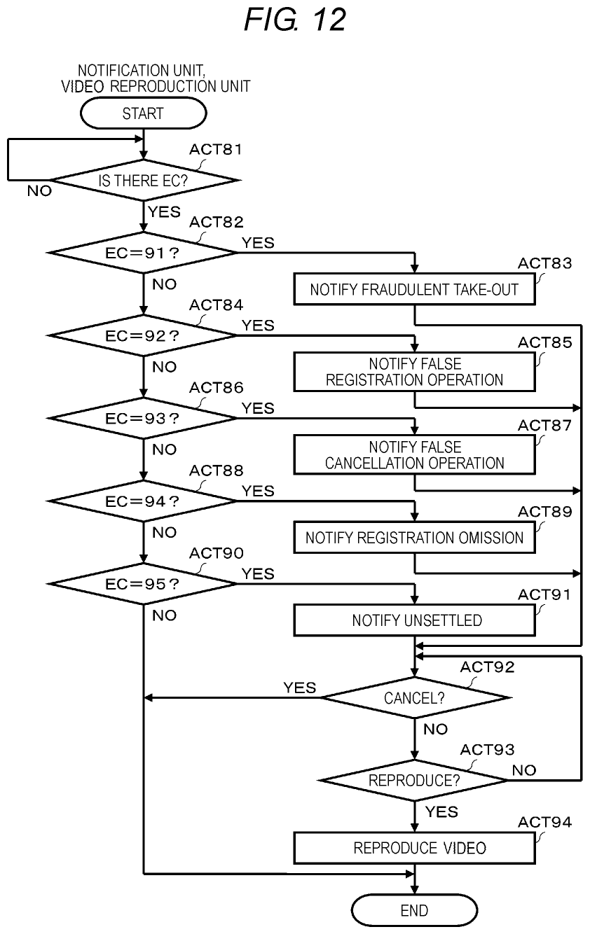

FIG. 12 is a flowchart illustrating functions as the notification unit 234 and the video reproduction unit 235. The processor 81 waits for the error code EC to be described in the time series buffer 822 in ACT 81. If the error code EC is described in the time series buffer 822, the processor 81 determines YES in ACT 81 and proceeds to ACT 82. The processor 81 confirms whether the error code EC is “91” in ACT 82.

If the error code EC is “91”, the processor 81 determines YES in ACT 82 and proceeds to ACT 83. The processor 81 notifies the fraudulent behavior “fraudulent take-out” in ACT 83. That is, the processor 81 searches the message table 821 and acquires message data having the error code EC of “91”. The processor 81 acquires a registration number of the time series buffer 822 in which “91” is described as the error code EC. Next, the processor 81 outputs a notification command to which the message data and the registration number are added from the communication interface 86 to the display control apparatus 13.

The display control apparatus 13 displays a text of the message data on the monitoring image SC identified by the registration number included in the notification command. As a result, on the monitoring image SC, for example, a text notifying the fraudulent behavior such as “fraudulent take-out is performed at register of registration No. X” is displayed. However, the display control apparatus 13 replaces “X” in the text with the registration number included in the notification command. Therefore, the attendant can warn a customer, who is using the self-service POS terminal 11 in which the registration number shown in the displayed text is set, that the fraudulent behavior “fraudulent take-out” is performed.

If the error code EC is not “91”, the processor 81 determines NO in ACT 82 and proceeds to ACT 84. The processor 81 confirms whether the error code EC is “92” in ACT 84.

If the error code EC is “92”, the processor 81 determines YES in ACT 84 and proceeds to ACT 85. The processor 81 notifies the fraudulent behavior “false registration” in ACT 85. That is, the processor 81 searches the message table 821 and acquires message data having the error code EC of “92”. The processor 81 acquires a registration number of the time series buffer 822 in which “92” is described as the error code EC. Next, the processor 81 outputs a notification command to which the message data and the registration number are added from the communication interface 86 to the display control apparatus 13.

The display control apparatus 13 displays a text of the message data on the monitoring image SC identified by the registration number included in the notification command. As a result, on the monitoring image SC, for example, a text notifying the fraudulent behavior such as “false registration is performed at register of registration No. X” is displayed. However, the display control apparatus 13 replaces “X” in the text with the registration number included in the notification command. Therefore, the attendant can warn a customer, who is using the self-service POS terminal 11 in which the registration number shown in the displayed text is set, that the fraudulent behavior “false registration” is performed.

If the error code EC is not “92”, the processor 81 determines NO in ACT 84 and proceeds to ACT 86. The processor 81 confirms whether the error code EC is “93” in ACT 86.

If the error code EC is “93”, the processor 81 determines YES in ACT 86 and proceeds to ACT 87. The processor 81 notifies the fraudulent behavior “false cancellation” in ACT 87. That is, the processor 81 searches the message table 821 and acquires message data having the error code EC of “93”. The processor 81 acquires a registration number of the time series buffer 822 in which “93” is described as the error code EC. Next, the processor 81 outputs a notification command to which the message data and the registration number are added from the communication interface 86 to the display control apparatus 13.

The display control apparatus 13 displays a text of the message data on the monitoring image SC identified by the registration number included in the notification command. As a result, on the monitoring image SC, for example, a text notifying the fraudulent behavior such as “false cancellation is performed at register of registration No. X” is displayed. However, the display control apparatus 13 replaces “X” in the text with the registration number included in the notification command. Therefore, the attendant can warn a customer, who is using the self-service POS terminal 11 in which the registration number shown in the displayed text is set, that the fraudulent behavior “false cancellation” is performed.

If the error code EC is not “93”, the processor 81 determines NO in ACT 86 and proceeds to ACT 88. The processor 81 confirms whether the error code EC is “94” in ACT 88.

If the error code EC is “94”, the processor 81 determines YES in ACT 88 and proceeds to ACT 89. The processor 81 notifies the fraudulent behavior “registration omission” in ACT 89. That is, the processor 81 searches the message table 821 and acquires message data having the error code EC of “94”. The processor 81 acquires a registration number of the time series buffer 822 in which “94” is described as the error code EC. Next, the processor 81 outputs a notification command to which the message data and the registration number are added from the communication interface 86 to the display control apparatus 13.

The display control apparatus 13 displays a text of the message data on the monitoring image SC identified by the registration number included in the notification command. As a result, on the monitoring image SC, for example, a text notifying the fraudulent behavior such as “registration omission is performed at register of registration No. X” is displayed. However, the display control apparatus 13 replaces “X” in the text with the registration number included in the notification command. Therefore, the attendant can warn a customer, who is using the self-service POS terminal 11 in which the registration number shown in the displayed text is set, that the fraudulent behavior “registration omission” is performed. If the error code EC is not “94”, the processor 81 determines NO in ACT 88 and proceeds to ACT 90. The processor 81 confirms whether the error code EC is “95” in ACT 90.

If the error code EC is “95”, the processor 81 determines YES in ACT 90 and proceeds to ACT 91. The processor 81 notifies the fraudulent behavior “unsettled” in ACT 91. That is, the processor 81 searches the message table 821 and acquires message data having the error code EC of “95”. The processor 81 acquires a registration number of the time series buffer 822 in which “95” is described as the error code EC. Next, the processor 81 outputs a notification command to which the message data and the registration number are added from the communication interface 86 to the display control apparatus 13.

The display control apparatus 13 displays a text of the message data on the monitoring image SC identified by the registration number included in the notification command. As a result, on the monitoring image SC, for example, a text notifying the fraudulent behavior such as “register of registration No. X is unsettled” is displayed. However, the display control apparatus 13 replaces “X” in the text with the registration number included in the notification command. Therefore, the attendant can warn a customer, who is using the self-service POS terminal 11 in which the registration number shown in the displayed text is set, that the fraudulent behavior “unsettled” is performed.

When completing any one of ACT 83, ACT 85, ACT 87, ACT 89, and ACT 91, the processor 81 proceeds to the standby state of ACT 92 and ACT 93. The processor 81 waits for an instruction to cancel the notification in ACT 92 or an instruction to reproduce the video in ACT 93.

If the attendant wants to confirm an actual behavior of a customer who is a target of the notification, with respect to the notification executed as described above in ACT 83, ACT 85, ACT 87, ACT 89, and ACT 91 by the processor 81, for example, the attendant instructs reproduction of the video by a predetermined operation with the attendant terminal 24. For example, when displaying the text of the message data for various error notifications on the monitoring image SC, the display control apparatus 13 causes the monitoring image SC to display a user interface such as a soft key or the like for instructing the reproduction of the video. Next, the attendant instructs the reproduction of the video by, for example, operating the user interface. The attendant terminal 24 requests the fraudulent behavior recognition apparatus 23 to reproduce the video if the corresponding operation is performed.

If the fraudulent behavior recognition apparatus 23 receives the request for reproducing the video from the attendant terminal 24 as such, the processor 81 of the fraudulent behavior recognition apparatus 23 determines YES in ACT 93 and proceeds to ACT 94. The processor 81 instructs the attendant terminal 24 to reproduce the video in ACT 94. For example, the processor 81 acquires a registration number of the time series buffer 822 in which the error code EC is described if YES is determined in ACT 81. Next, the processor 81 reads out, from the image storage apparatus 22, imaging data of a part of a reproduction range of the imaging data stored in the image storage apparatus 22 in association with the acquired registration number. For example, the processor 81 determines the reproduction range based on the time TM described in the time series buffer 822 in association with the error code EC described if YES is determined in ACT 81. Next, the processor 81 sends the read imaging data to the attendant terminal 24 via the communication interface 86. As described above, the functions as the notification unit 234 and the video reproduction unit 235 are completed.

The reproduction range is, for example, a time range from time that goes back from the time TM to predetermined reproduction time to the time TM. The reproduction time may be freely and selectively determined by a designer or an administrator of the fraudulent behavior recognition apparatus 23. However, the reproduction time is required to be set to include a period during which various fraudulent behaviors are photographed. The reproduction time may be individually determined according to the error code EC. For example, if “92” is described as the error code EC, a video at least showing the bagging behavior may be able to be reproduced. On the other hand, if “94” is described as the error code EC, and if it is required to reproduce a video showing a portion from the settlement start operation to the merchandise take-out behavior, an optimum value of the reproduction time here is larger than an optimum value of the reproduction time related to the case where “92” is described as the error code EC. Therefore, it is effective to set individual reproduction time in consideration of the optimum value of the reproduction time of each error.

When receiving the imaging data sent from the fraudulent behavior recognition apparatus 23 as such, the attendant terminal 24 reproduces the video represented by the imaging data on the display. As a result, the attendant can confirm the behavior of the customer related to the fraudulent behavior notified by the text immediately before.

As described above, by collaboration of the function of the video reproduction unit 235 in the fraudulent behavior recognition apparatus 23 and the attendant terminal 24, the video based on the imaging data in the range identified by the time TM as an index is reproduced. Thus, the processor 81 executes the information process, such that the computer including the processor 81 as the central portion implements a function as a first reproduction unit in cooperation with the attendant terminal 24.

The time TM described in the time series buffer 822 in association with the error code EC corresponds to index data that can identify an area of the imaging data in which the fraudulent behavior is shown. Next, as described above, the processor 81 describes the time TM in the time series buffer 822 in association with the error code EC, such that the index data is recorded. That is, if the processor 81 executes the information process, the computer including the processor 81 as the central portion functions as a recording unit.

Meanwhile, for example, with respect to the notification in ACT 83 or ACT 91, it may be effective for the attendant to promptly speak to the customer. Here, the attendant gives an instruction to cancel the notification by, for example, a predetermined operation in the attendant terminal 24. For example, when displaying the texts of the message data for various error notifications on the monitoring image SC, the display control apparatus 13 causes the monitoring image SC to display a user interface such as a soft key for instructing the cancellation of the notification. Next, the attendant gives the instruction to cancel the notification by operating the user interface. The attendant terminal 24 requests the fraudulent behavior recognition apparatus 23 to cancel the notification if the corresponding operation is performed.

When receiving the notification cancellation request from the attendant terminal 24 as such, the fraudulent behavior recognition apparatus 23 allows the processor 81 to determine YES in ACT 92 and to end the functions of the notification unit 234 and the video reproduction unit 235.

As described in detail above, the fraudulent behavior recognition apparatus 23 has, as the behavior recognition unit 231 and the fraud determination unit 233, a function of detecting the fraudulent behavior of the customer with respect to the self-service POS terminal 11 based on the imaging data of the camera 21. The fraudulent behavior recognition device 23 has, as the fraud determination unit 233, a function of recording the time TM as the index data that can identify the range of the imaging data in which the behavior detected as the fraudulent behavior is shown. Therefore, according to the fraudulent behavior recognition apparatus 23, the range of the imaging data showing the behavior detected as the fraudulent behavior can be easily identified based on the time TM, such that the attendant can promptly confirm the erroneous behavior related to the operation of the self-service POS terminal 11 by confirming the imaging data in the range.

The fraudulent behavior recognition system 200 stores the imaging data in a storage device provided in the image storage apparatus 22. In response to the reproduction instruction of the attendant terminal 24, the fraudulent behavior recognition system 200 allows the video reproduction unit 235 to display, on the attendant terminal 24, the video based on the imaging data in the range identified based on the recorded time TM among the stored imaging data. Therefore, according to the fraudulent behavior recognition system 200, it is possible to allow the attendant to promptly confirm the erroneous behavior related to the operation of the self-service POS terminal 11. These embodiments can be modified in various ways as follows. The processor 81 may proceed from at least one of ACT 83, ACT 85, ACT 87, ACT 89 and ACT 91 of FIG. 12 to ACT 94. That is, the processor 81 may reproduce the video in which the fraudulent behavior is shown in response to the detection of the fraudulent behavior without receiving the reproduction instruction. Here, the computer including the processor 81 as the central portion functions as a second reproduction unit.

The index data may be data representing start timing of the video range in which the fraudulent behavior is shown. Alternatively, the index data may be data respectively representing the start timing and end timing of the video range in which the fraudulent behavior is shown. The index data may be any data as long as the index data can identify the video range in which the fraudulent behavior is shown.

The camera 21 may not be provided in the fraudulent behavior recognition system 200. That is, a monitoring camera or the like provided on the self-service POS terminal 11 or a ceiling of a store for the purpose of crime prevention can be used instead of the camera 21.

The image storage apparatus 22 may not be provided in the fraudulent behavior recognition system 200. The imaging data may be stored in the auxiliary storage device 83 or a storage device separately provided in the fraudulent behavior recognition apparatus 23.

At least one embodiment describes a case in which one camera 21 is disposed for one self-service POS terminal 11. The camera 21 may not be necessarily disposed for each self-service POS terminal 11. For example, if a customer who operates two adjacent self-service POS terminals 11 can be photographed by one camera 21, the number of cameras 21 may be reduced. However, here, in ACT 2 of FIG. 7, the registration number of the self-service POS terminal 11 closest to a location of a person shown in a video is acquired.

The embodiment describes a case in which the notification unit 234 gives the notification to the attendant via the attendant terminal 24. A notification destination is not limited to the attendant terminal 24. For example, the self-service POS terminal 11 on which the fraudulent behavior is performed may be set as the notification destination. Here, for example, the light emitting unit 65 emits light with a predetermined color to notify a clerk that the fraudulent behavior is performed. Alternatively, a warning message is displayed on the touch panel 41 to notify a customer that the fraudulent behavior is detected. A warning of the fraudulent behavior may be issued by a display or a voice by wireless communication with a communication terminal carried by a clerk.

In at least one embodiment, the attendant terminal 24 may include a function of the display control apparatus 13. Here, the operation recognition unit 232 acquires the data of the monitoring image SC from the attendant terminal 24 and recognizes a customer's operation with respect to the self-service POS terminal 11. Alternatively, the operation recognition unit 232 may receive a data signal output from each self-service POS terminal 11 from the communication network 14 via, for example, a router, and may recognize the customer's operation with respect to the self-service POS terminal 11 based on the data signal.

While certain embodiments have been described, the embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A monitoring apparatus, comprising:
a detector configured to detect an erroneous behavior of an operator based on video data, the video data obtained by photographing a behavior of the operator who operates a settlement terminal; and
a recorder configured to record index data that can identify a range of the video data in which the behavior detected by the detector is shown.

2. A monitoring system, comprising:
a photographing device configured to photograph a behavior of an operator who operates a settlement terminal;
a storage configured to store video data obtained by the photographing device;
a detector configured to detect an erroneous behavior of the operator based on the video data; and
a recorder configured to record index data that can identify in which range of the video data the behavior detected by the detector is shown.

3. The system according to claim 2, further comprising:
a first reproduction configured to reproduce a video based on video data in a range identified by the index data recorded by the recorder among the video data stored in the storage device.

4. The system according to claim 2, further comprising:
a second reproduction configured to reproduce, in response to detection of the erroneous behavior by the detector, a video based on video data in a range referred to for the detection of the erroneous behavior among the video data stored in the storage.

5. A monitoring method, comprising:
detecting an erroneous behavior of an operator based on video data, the video data obtained by photographing a behavior of the operator who operates a settlement terminal; and
recording index data that can identify a range of the video data in which the detected behavior is shown.

6. The apparatus according to claim 1, wherein the erroneous behavior includes fraudulent behavior.

7. The apparatus according to claim 6, further including a fraud determining processor configured to determine the fraudulent behavior.

8. The apparatus according to claim 7, further including a fraud notifying processor configured to provide notification messages of fraudulent behavior to an attendant terminal.

9. The apparatus according to claim 8, further including a message table storing the notification messages.

10. The apparatus according to claim 1, wherein the settlement terminal is a point of sale terminal.

11. The system according to claim 2, wherein the photographing device includes a video camera.

12. The system according to claim 2, wherein the settlement terminal is a point of sale terminal.

13. The system according to claim 2, wherein the erroneous behavior includes fraudulent behavior.

14. The system according to claim 13, further including a fraud determining processor configured to determine the fraudulent behavior.

15. The system according to claim 14, further including a fraud notifying processor configured to provide notification messages of fraudulent behavior to an attendant terminal.

16. The system according to claim 15, further including a message table storing the notification messages.
